(19) United States
(12) Patent Application Publication
(10) Pub. No.: US 2025/0295558 A1
(43) Pub. Date: Sep. 25, 2025

(54) WEARABLE ANIMAL VACCINE INSULATION APPARATUS

(71) Applicant: Marnie FISHER, Humpty Doo (AU)

(72) Inventor: Marnie FISHER, Humpty Doo (AU)

(21) Appl. No.: 19/105,229

(22) PCT Filed: Aug. 22, 2023
(86) PCT No.: PCT/AU2023/050795

§ 371 Date: Feb. 20, 2025

(30) Foreign Application Priority Data
Aug. 23, 2022 (AU) 2022902404
Jul. 18, 2023 (AU) 2023902297

(51) Int. Cl. A61J 1/16; A61J 1/14; B65D 81/38; B65D 83/00

(52) U.S. Cl. CPC A61J 1/165; A61J 1/1475; B65D 81/3827; B65D 81/3832; B65D 83/771; B65D 2583/005

(57) ABSTRACT

A wearable animal vaccine insulation apparatus consists of an insulated container with an interior for a vaccine delivery bladder. It features a delivery opening to connect the bladder's neck to a dose administration hose. The apparatus also includes a body harness for wearing the container against the body. The container maintains the temperature integrity of the vaccine delivery bladder ensuring that the vaccine remains within the recommended temperature range, safeguarding its effectiveness.

### FIELD OF THE INVENTION

This invention relates generally to apparatus for thermally insulating animal vaccine during administration.

### BACKGROUND OF THE INVENTION

Livestock vaccination is a critical aspect of maintaining the health and productivity of animals within the agricultural industry. One common method used for administering vaccines to livestock involves the use of a hypodermic needle gun, which delivers the vaccine through a delivery hose connected to a bladder containing the vaccine solution.

The vaccine contained within these bladders is meticulously formulated to protect animals from specific diseases. To preserve the efficacy of the vaccine, it is essential to store it within a specific temperature range of 2° C. to 8° C. (35.6° F. to 46.4° F.). This temperature range, known as the cold chain, ensures that the vaccine's active ingredients remain stable and effective.

Transporting the vaccine under appropriate temperature conditions is crucial to maintaining its potency. To achieve this, specialised cool boxes are employed during transportation. These cool boxes are designed to insulate the vaccine from external temperature fluctuations, safeguarding it from getting too warm or too cold.

However, a challenge arises when the vaccine is put to use. In practice, there are instances where the vaccine's temperature exceeds the recommended range, thereby compromising its effectiveness. This situation is particularly problematic because variations in temperature can degrade the vaccine's active components, rendering it less potent or entirely ineffective. Factors contributing to the temperature deviations include exposure to ambient temperature and body heat during administration.

The present invention seeks to provide a way to overcome or substantially ameliorate at least some of these problems, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a wearable animal vaccine insulation apparatus which consists of an insulated container designed to hold a flexible vaccine delivery bladder. The bladder is typically made of biocompatible materials like plastic or silicon. The container has a delivery opening for connecting the bladder's neck to a delivery hose. The apparatus includes a body harness for wearing the container against the body.

The container design effectively shields the bladder from body heat exposure while being worn.

The container has a wide insertion opening opposite the delivery opening, allowing the bladder to be conveniently inserted lengthwise. When the bladder is empty, it can be removed through this opening and replaced with a full bladder. The container is often made of polystyrene.

In one version, the container has bifurcated portions that form the interior and the delivery opening. These portions allow for easy insertion and removal of bladders even when connected together. The apparatus may also include cool pack containers for replaceable cool packs that help maintain the vaccine's temperature within the bladder. These cool packs are inserted into slots and can be replaced without disassembling the apparatus.

Some versions include a fabric covering for the container. This covering seals the container and the bladder from ambient air, while still allowing easy access for replenishing the bladder or cool packs. The harness holds the delivery opening downwardly to enable vaccine flow by gravity.

A swivel mechanism may be present, allowing variable orientation of the strap with respect to the container, providing comfort during wear. The vaccine is delivered by connecting the bladder to a delivery hose and using a delivery gun/syringe. Cool packs can be replaced, and when the bladder is empty, it can be replaced by sliding it out and inserting a fresh bladder through the wide opening.

Additional embodiments involve a rectangular outer case, neoprene-insulated, with a delivery opening for the bladder's neck. An over-the-shoulder harness is connected to the case. A container inside the case has an upper wide opening for the bladder. The container portions may be hollow and contain liquid or gel coolant. Stand-offs in the container regulate thermal conductivity between the bladder and the container.

Overall, the apparatus aims to provide a practical solution for efficiently administering vaccines to livestock while maintaining the vaccine's temperature and integrity. It includes features for easy insertion, replacement, cooling, and comfortable wearing.

The container offers several significant advantages in the context of administering vaccines to animals. One key advantage lies in its ability to maintain the temperature integrity of the vaccine delivery bladder. By incorporating insulation and a cool pack system, the container ensures that the vaccine remains within the recommended temperature range, safeguarding its effectiveness.

Moreover, the container's design contributes to ease of use. The wide insertion opening simplifies the process of replacing depleted bladders with fresh ones, and the provision for cool pack insertion allows for active cooling without the need for disassembly. This convenience extends to the harness, which securely positions the container against the body, optimizing vaccine delivery and minimizing the risk of contamination.

Additionally, the container's incorporation of a fabric covering serves a dual purpose. It not only helps maintain the desired temperature but also provides a protective barrier against ambient air and external elements. This covering, often designed to be resilient, enables the apparatus to be worn comfortably while ensuring the vaccine and cool packs are shielded from temperature fluctuations.

Another advantage lies in user comfort and practicality. The optional swivel mechanism enhances the usability of the harness by allowing variable orientation, accommodating wearers' preferences while maintaining the container's upright position. This attention to ergonomic design contributes to a more efficient and comfortable vaccine administration process.

In summary, the container's comprehensive design advantages encompass temperature regulation, ease of use, protective measures, and user comfort. These aspects collectively enhance the effectiveness and practicality of the wearable animal vaccine insulation apparatus during livestock vaccination.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a disassembled view of a wearable animal vaccine insulation apparatus in accordance with an embodiment;

FIG. 2 shows the apparatus assembled;

FIG. 3 shows a cross-section of the apparatus;

FIG. 4 shows a front elevation view of the apparatus;

FIG. 5 shows a side elevation view of the apparatus;

FIGS. 6 and 7 shows an embodiment of the apparatus having a chest mounting swivel harness;

FIG. 8 shows a wearable animal vaccine installation apparatus in accordance with a further embodiment;

FIG. 9 shows a perspective view of the container portion of the apparatus of FIG. 8;

FIG. 10 shows a cross-sectional view of the apparatus of FIG. 8;

FIG. 11 shows a top perspective view of a container of the apparatus of FIG. 8; and

FIG. 12 shows a cross-sectional view of the apparatus of FIG. 8.

### DESCRIPTION OF EMBODIMENTS

A wearable animal vaccine insulation apparatus 100 comprises an insulated container 101 defining an interior for a vaccine delivery bladder 102. The bladder 102 typically comprises a flexible body such as of biocompatible plastic, silicon or the like.

The container 101 further defines a delivery opening 103 for connection of a neck 104 of the bladder 102 to a delivery hose.

The apparatus 100 further comprises a body harness 105 for wearing the container 101 against the body in use.

The container 101 preferably defines a wide insertion opening 106 opposite the delivery opening 103 for the insertion of the bladder 102. The insertion opening 106 preferably has a cross-section greater than that of the bladder 102.

As such, the container 101 allows the convenient longitudinal insertion of the bladder 102 into the container 101 so that the neck 104 thereof protrudes from the delivery opening 103 of the container 101. When the bladder 102 is depleted, the depleted bladder 102 can be removed from the insertion opening 106 and replaced with a full replacement bladder 102.

The container 101 preferably comprises polystyrene.

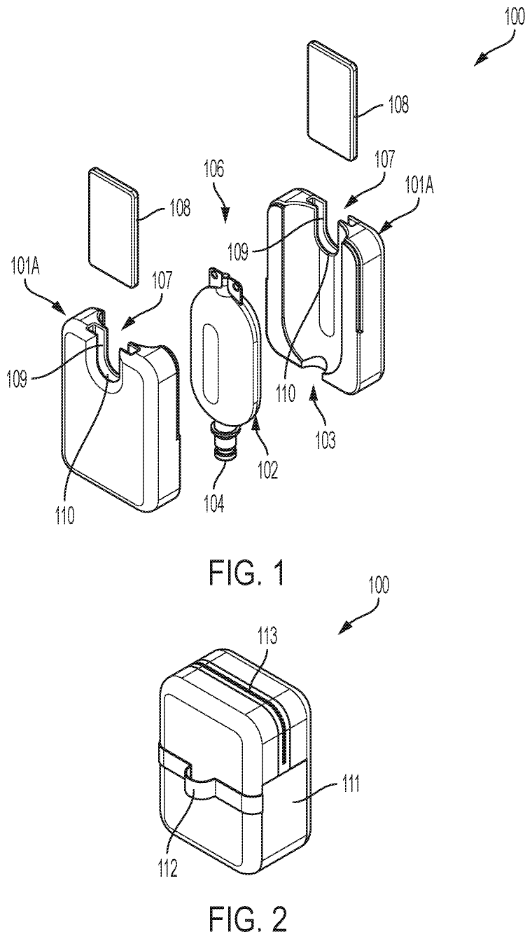

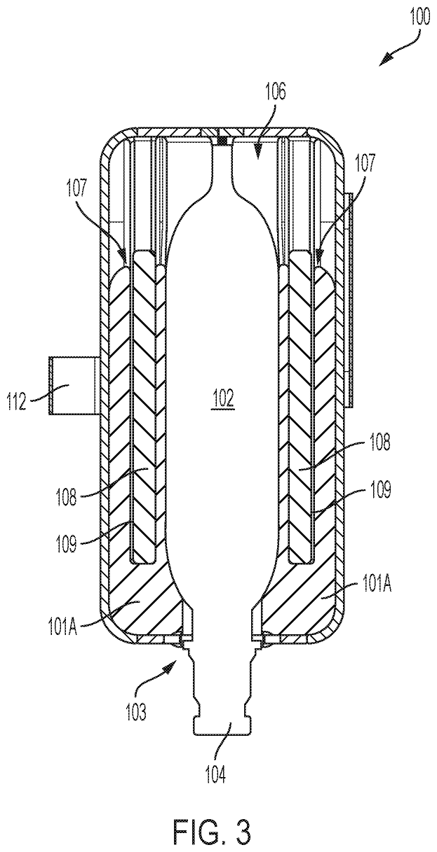

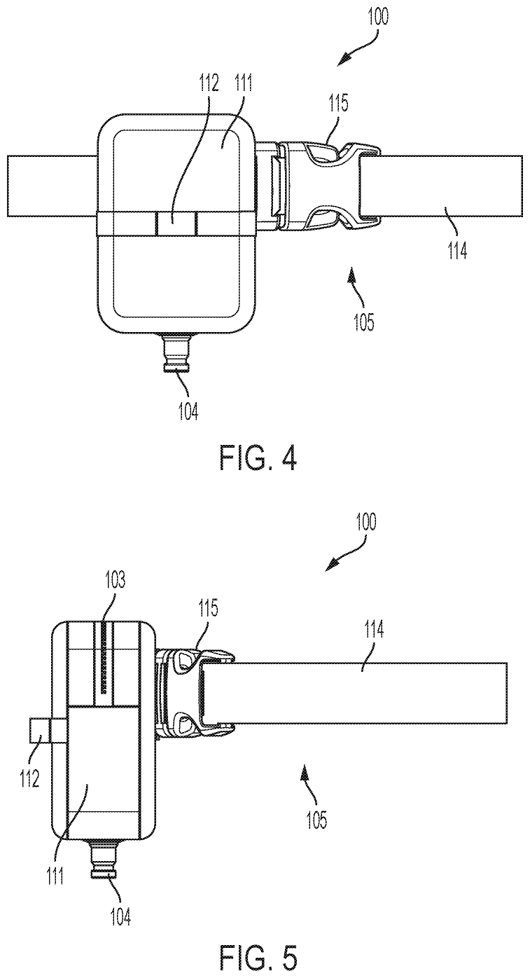

According to the preferred embodiment shown in FIG. 1, the container 101 has bifurcated portions 101A which cooperate to form the interior and the delivery opening 103 therebetween. Furthermore, the bifurcated portions 101A cooperate to define the wide insertion opening 106 opposite the delivery opening 103.

According to this configuration, the bifurcated portions 101A yet allow the convenient insertion and removal of bladders 102 via the wide opening 106 even when connected together. In other words, the bifurcated portions 101A need not be taken apart to replace the bladder 102.

In a preferred embodiment, the apparatus 100 comprises at least one cool pack container 107 for replaceable insertion of a cool pack 108 therein for active cooling of vaccine within the bladder 102.

In the embodiment shown, the cool pack 108 is generally rectangular and wherein the cool pack container 107 comprises a slot 109 into which the cool pack 108 can be slotted in use. In accordance with this embodiment, the cool pack 108 may comprise a rectangular plastic shell having coolant gel therein.

In the embodiment shown, each bifurcated portion 101 comprises a respective slot 109 so that the apparatus 100 may hold cool packs 108 either side of the bladder 102. Each slot 109 may comprise a central recess 110.

Openings into the slots 109 may be located opposite the delivery opening 103 so that the bladder 102 and the cool packs 108 may be removed from the top of the apparatus 100. Furthermore, the cool packs 108 may be replaced without having to disassemble the bifurcated portions 101A.

FIG. 2 shows wherein the apparatus 100 comprises a fabric covering 111 for the insulated container 101. The covering 111 may comprise a suitably resilient fabric such as canvas. The bifurcated portions 101A may form a generally rectangular container 101 and the fabric covering 111 may be conformingly rectangular.

The covering 111 may expose a loop 112 for stowing a hypodermic needle delivery gun/syringe of the delivery hose.

The covering 111 may define an opening 113 coinciding with the wide opening 106 of the container 101. In the embodiment shown, the cover opening 113 takes the form of a zip running across the top of the container 101.

As such, the covering 111 seals the container 101 and the bladder therein from ambient air and yet allows convenient replenishment of the bladder 102 and/or cool packs 108 via the opening 113 across the top of the container 101.

The harness 105 preferably holds the delivery opening 103 downwardly so that vaccine flows from the bladder 102 under gravity.

In the embodiment shown, the harness 105 comprises a strap 114 which may be connected with a buckle 115.

Preferably, the harness 105 is configured so that the container 101 can be worn high to increase hydrostatic pressure. In this regard, the harness 105 may be configured for wearing the container 101 across the chest.

In accordance with this arrangement, the strap 114 may be worn across the chest, over one shoulder and under the other.

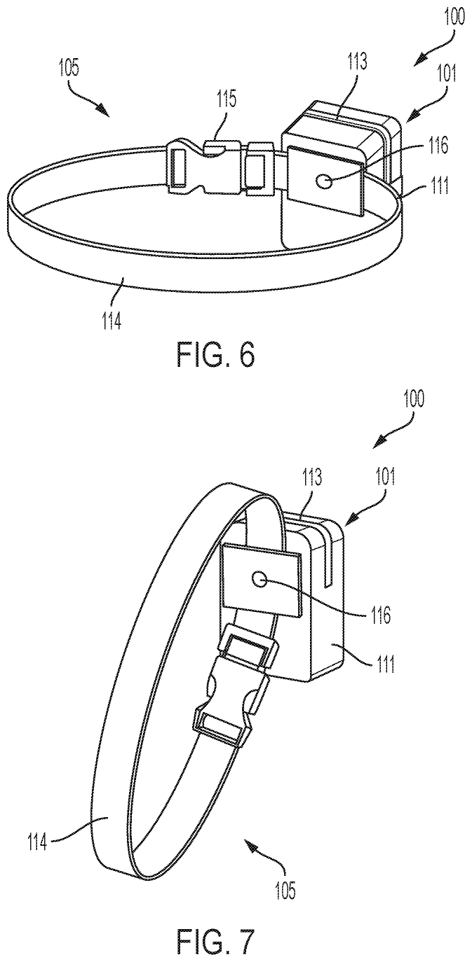

According to the embodiment shown in FIGS. 6 and 7, the apparatus 100 may comprise a swivel 116 to allow variable orientation of the strap 114 with respect to the container 101. As such, the swivel 116 may hold the strap 114 at an angle suitable for going around the chest whilst holding the container 101 upright.

Vaccine delivery using the apparatus 100 may comprise putting the bifurcated portions 101A together and enclosing the bifurcated portions 101A within the covering 111.

The zip 113 may be opened to insert fresh cool packs 118 into respective slots 109 of the container 101 and to insert a full bladder 102 into the interior of the container 101 via the wide opening 106 until the neck 104 thereof protrudes from the delivery opening 103.

The zip 113 may then be closed. A delivery hose may be connected to the neck 104.

The buckle 115 may be unclipped and the strap 114 placed over one shoulder and under the other so that the container 101 is positioned across the chest of the wearer. The buckle 115 may then be reconnected.

The swivel 116 may allow the strap 114 to be worn at an angle in this manner whilst holding the container 101 upright.

Vaccine may be then delivered to livestock from a delivery gun/syringe at a distal end of the delivery hose. The high positioning of the container 101 increases hydrostatic pressure aiding vaccine delivery.

At periodic intervals, the cool packs 108 may be replenished by opening the zip 113, sliding the installed cool packs 108 from the slots 109, inserting fresh cool packs 108 into the slots 109 and closing the zip 113.

When the bladder 102 is depleted, the bladder 102 may be replaced by opening the zip 113, disconnecting the delivery hose from the neck 104 of the installed bladder 102 and sliding the bladder 102 from between the bifurcated portions 101A and out via the wide opening 106. A fresh bladder 102 can then be inserted into the opening of the container 101 between the bifurcated portions 101A via the wide opening 106 thereof until the neck 104 of the bladder 102 extends through the delivery opening 103 whereafter the delivery hose can be reattached to the neck 104 and the zip 113 closed.

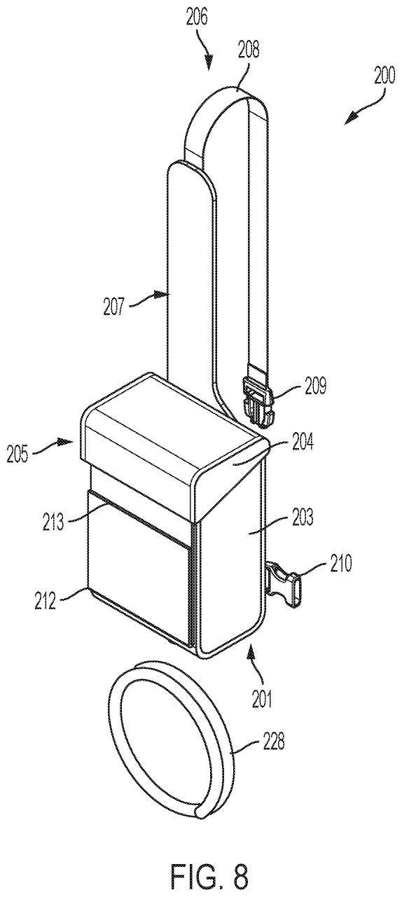

FIGS. 8-12 show a wearable animal vaccine installation apparatus 200 in accordance with a further embodiment. With reference to FIG. 8, the apparatus 200 may comprise a generally rectangular outer case 201.

With reference to FIG. 10, the outer case 201 may be formed by an insulated main panel 202 which is folded back on itself to define the front, bottom, rear and top of the outer case 201.

With reference to FIG. 8, bottom side panels 203 may be joined to respective edges of the main panel 202 to enclose sides of a main portion of the case 201 and top side panels 204 may be joined to respective edges of the main panel 202 to form a generally squarish lid 205 encloses the interior of the case 201.

A bottom portion of the main panel 202 may have a delivery opening 215 therethrough to accommodate the neck 216 of the bladder 220 which extends out from the case 201 for attachment to a delivery hose 228.

The main panel 202 may comprise a material such as neoprene which insulates the interior of the case 201 and which can flexibly bend at the rear of the lid 205 to allow opening and closing thereof. The lid 205 may increase in height towards the front of the case 201. The bottom side panels 203 and top side panels 204 may comprise similar material.

Hook and loop fasteners strips 211 may adhere opposite edge surfaces of the main panel 202.

The apparatus 200 may have an over-the-shoulder harness 206 connected from a rear of the case 201.

The harness 206 may comprise a flat panel 207 having an upper elongate portion extending up from the case 201 and having a lower widened portion which affixes to the rear of the case 201.

A strap 208 and buckle 209 may extend from an upper end of the flat panel 207 and which may connect to a buckle 210 extending from a side of the case 201, thereby completing a loop around a wearer's torso.

A pocket 214 for documents, needles or the like may be formed on a front surface of the case 201 by a panel 212 which is folded back on itself, and which comes up short on the front to thereby define an openable edge 213 into the pocket 214.

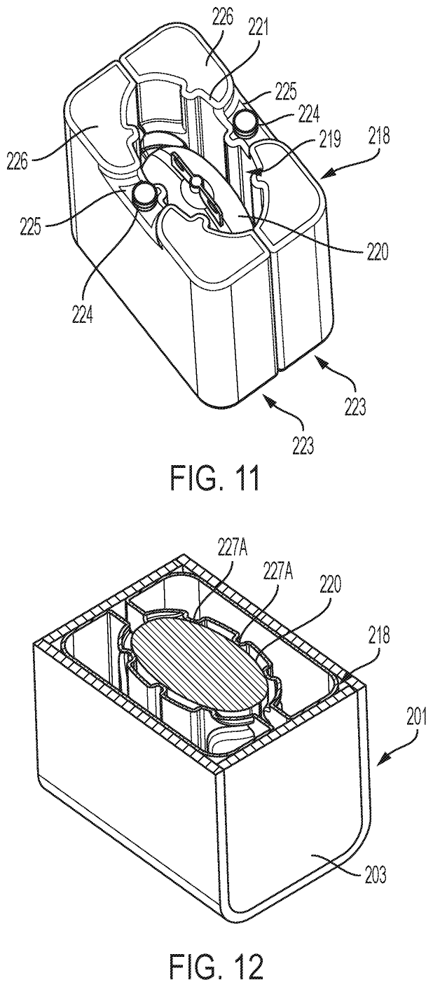

With reference FIG. 11, the apparatus 200 comprises a container 218 defining an interior 219 for the bladder 220.

The container 218 preferably defines an upper wide opening 221 having a cross-section greater than that of the bladder 220 so that the bladder 220 can slide into the interior 219. However, with reference to FIG. 10, the container 218 may have a lower narrowing 222 which holds the neck 216 and/or bottom portion of the bladder 220 to hold the bladder 220 within the interior 219 of the container 218.

The container 218 may be formed by two portions 223 which close together to form the interior 219 therebetween. As is shown in FIG. 12, the exterior of the container 218 closely conforms with the rectangular cross-section of the case 201.

The two container portions 223 are preferably hollow as is shown in FIG. 11. As such, the two container portions 223 may be filled with liquid or gel coolant which may be chilled.

Each portion 223 may comprise a respective cap lid 224 interfacing the interior of the container portion 223 and which may be non-removably affixed in embodiments. As is evident from FIG. 11, the lids 224 may be recessed within a shoulder 225 beneath an upper surface 226 of the container portion 223 to maximise the interior volume of the container portion 223.

Each container portion 223 may define stand-offs 227 which minimise the contact surface area against the bladder 220 to thereby regulate thermal conductivity between the container 218 and the bladder 220.

For example, were liquid or gel content within each container portion 223 frozen, the stand-offs 227 would limit thermal conduction between the liquid contents of the bladder 220 and the container 218 so that the liquid contents of the bladder 220 would not become too cold for administration.

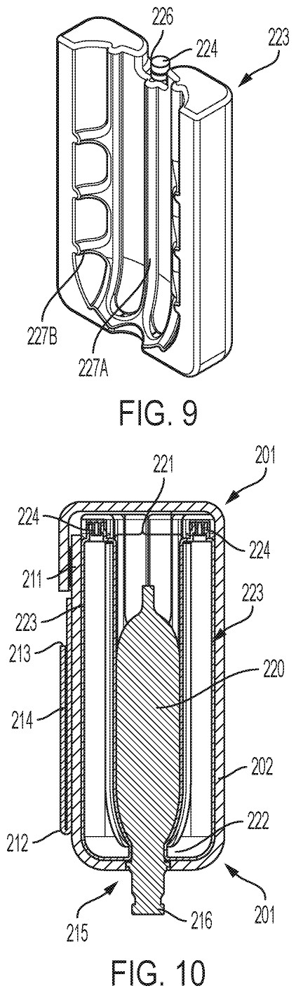

With reference to FIG. 9, the stand-offs 227 may comprise vertical stand-offs 227A and horizontal stand-offs 227B. The vertical stand-offs may be arranged to facilitate sliding of the bladder 220 into the interior 219. Generally, the horizontal stand-offs 227 are around the sides of the bladder 220.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. Wearable animal vaccine insulation apparatus comprising:
an insulated container defining:
an interior for a vaccine delivery bladder; and
a delivery opening for connection of the neck of the bladder to a dose administration hose; and
a body harness for wearing the container against the body.

2. The apparatus as claimed in claim 1, wherein the container defines a wide insertion opening opposite the delivery opening for the insertion of a vaccine delivery bladder.

3. The apparatus as claimed in claim 1, wherein the insulated container comprises polystyrene.

4. The apparatus as claimed in claim 1, wherein the insulated container has bifurcated portions which cooperate to form the interior and the delivery opening therebetween.

5. The apparatus as claimed in claim 4, wherein the bifurcated portions cooperate to define a wide insertion opening opposite the delivery opening for the insertion of a vaccine delivery bladder.

6. The apparatus as claimed in claim 4, wherein the bifurcated portions comprise polystyrene.

7. The apparatus as claimed in claim 1, wherein the apparatus comprises at least one cool pack container.

8. The apparatus as claimed in claim 7, wherein the cool pack container comprises a slot into which a cool pack can be inserted in use.

9. The apparatus as claimed in claim 8, wherein the insulated container defines a pair of slots on opposite sides of the interior.

10. The apparatus as claimed in claim 9, wherein the insulated container has bifurcated portions which cooperate to form the interior and the delivery opening therebetween and wherein each bifurcated portion comprises a slot.

11. The apparatus as claimed in claim 9, wherein openings to the slots are located opposite the delivery opening.

12. The apparatus as claimed in claim 9, wherein slot openings are recessed.

13. The apparatus as claimed in claim 1, further comprising a fabric covering for the insulated container.

14. The apparatus as claimed in claim 13, wherein the insulated container has bifurcated portions which cooperate to form the interior and the delivery opening therebetween and wherein the container is substantially rectangular and wherein the fabric covering is conformingly rectangular.

15. The apparatus as claimed in claim 13, wherein the container defines a wide insertion opening opposite the delivery opening for the insertion of a vaccine delivery bladder and wherein the fabric covering has an opening across the wide insertion opening.

16. The apparatus as claimed in claim 15, wherein the opening of the cover runs across a width of the container over a top of the container.

17. The apparatus as claimed in claim 1, wherein the harness orientates the delivery opening downwardly.

18. The apparatus as claimed in claim 1, wherein the harness comprises a strap.

19. The apparatus as claimed in claim 18, wherein the apparatus has a swivel interfacing the strap and the container.

20. A method of animal vaccine administration using the apparatus as claimed in claim 1, the method comprising inserting a vaccine delivery bladder into the interior of the container, attaching a delivery hose to a neck of the bladder via the delivery opening and delivering vaccine from the bladder via the hose.

21. The method as claimed in claim 20, further comprising the apparatus as claimed in claim 2, wherein the method comprises inserting a vaccine bladder into the container via the wide opening.

22. The method as claimed in claim 20, further comprising the apparatus as claimed in claim 7, wherein the method comprises inserting at least one cool pack into the at least one cool pack container.

23. The method as claimed in claim 20, further comprising the apparatus as claimed in claim 9, wherein the method comprises slotting in a pair of cool packs either side of the bladder from a side of the container opposite the delivery opening.

24. The apparatus as claimed in claim 1, wherein an outer case is formed by an insulated main panel which is folded back on itself to define the front, bottom, rear and top of the outer case.

25. The apparatus as claimed in claim 24, wherein bottom side panels join to respective edges of the main panel to enclose sides of a main portion of the case.

26. The apparatus as claimed in claim 24, wherein top side panels join respective edges of the main panel to form a generally squarish lid which encloses an interior of the case.

27. The apparatus as claimed in claim 24, wherein a bottom portion of the main panel has a delivery opening therethrough to accommodate a neck of the bladder.

28. The apparatus as claimed in claim 24, wherein the main panel comprises neoprene.

29. The apparatus as claimed in claim 26, wherein the lid increases in height towards the front of the case.

30. The apparatus as claimed in claim 26, wherein hook and loop fasteners strips adhere to opposite edge surfaces of the main panel.

31. The apparatus as claimed in claim 1, wherein the harness is an over-the-shoulder harness connected from a rear of the case.

32. The apparatus as claimed in claim 31, wherein the harness comprises a flat panel having an upper elongate portion extending up from the case and having a lower widened portion which affixes to the rear of the case.

33. The apparatus as claimed in claim 32, wherein a strap and buckle extend from an upper end of the flat panel and which connects to a female buckle extending from a side of the case.

34. The apparatus as claimed in claim 24, wherein a pocket is formed on a front surface of the case by a panel which is folded back on itself, and which comes up short in front to thereby define an openable edge into the pocket.

35. The apparatus as claimed in claim 1, wherein the container defines an upper wide opening having a cross-section greater than that of the bladder so that the bladder can slide into the interior.

36. The apparatus as claimed in claim 35, wherein the container has a lower narrowing holds a neck and/or bottom portion of the bladder to keep the bladder within the container.

37. The apparatus as claimed in claim 1, wherein the container is formed by two portions which close together to form an interior therebetween.

38. The apparatus as claimed in claim 1, wherein an exterior of the container closely conforms with the rectangular cross-section of the case.

39. The apparatus as claimed in claim 37, wherein the container portions are hollow.

40. The apparatus as claimed in claim 39, wherein the container portions are filled with liquid or gel coolant.

41. The apparatus as claimed in claim 39, wherein each portion comprises a respective lid.

42. The apparatus as claimed in claim 41, wherein each lid is recessed within a shoulder beneath an upper surface of the container portion.

43. The apparatus as claimed in claim 37, wherein each container portion defines stand-offs which minimise the contact surface area against the bladder.

44. The apparatus as claimed in claim 43, wherein the stand-offs comprise vertical stand-offs and horizontal stand-offs.

45. The apparatus as claimed in claim 44, wherein the vertical stand-offs are arranged to facilitate sliding of the bladder into the interior.

46. The apparatus as claimed in claim 44, wherein the horizontal stand-offs are around the sides of the bladder.
